(19) United States
(12) Patent Application Publication
(10) Pub. No.: US 2010/0305384 A1
(43) Pub. Date: Dec. 2, 2010

(54) Process for Converting Alkaline-Earth Metal Chlorides to Tungstates and Molybdates and Applications Thereof

(75) Inventors: Damien Hudry, Avignon (FR); Isabelle Bardez, Avignon (FR); Florence Bart, Orsan (FR); Philippe Deniard, Suce Sur Erdre (FR); Stéphane Jobic, Bougueanais (FR)

Correspondence Address: MILES & STOCKBRIDGE PC, 1751 PINNACLE DRIVE, SUITE 500, MCLEAN, VA, 22102-3833, US

(73) Assignees: COMMISSARIAT A L'ENERGIE ATOMIQUE, Paris (FR); CENTRE NATIONAL DE LA RECHERCHE SCIENTIFIQUE, Paris (FR)

(21) Appl. No.: 12/675,135

(22) PCT Filed: Sep. 2, 2008
(86) PCT No.: PCT/EP2008/061563

§ 371 Date: Aug. 11, 2010

(30) Foreign Application Priority Data
Sep. 4, 2007 (FR) 07 57345

(51) Int. Cl. G21C 19/48; C01G 41/00; C01G 39/00

(52) U.S. Cl. 588/18; 423/594.13; 423/594.16

(57) ABSTRACT

The invention relates to a process for converting an alkaline-earth metal chloride to at least one salt chosen from the tungstates and molybdates of this metal, which comprises the reaction of the alkaline-earth metal chloride with at least one precursor of tungsten or of molybdenum chosen from tungsten oxides, molybdenum oxides, tungstates and molybdates, this reaction being carried out in a solvent constituted by KCl or by an LiCl/KCl mixture and at a temperature at least equal to the melting point of this solvent.

Applications: synthesis of alkaline-earth metal tungstates and molybdates, extraction of alkaline-earth metals from media in which they are found in the form of chlorides, recovery of alkaline-earth fission products from a salt flux in the context of the reprocessing of a spent nuclear fuel in molten chloride media, etc.

### TECHNICAL FIELD

The present invention relates to a process that makes it possible to convert alkaline-earth metal chlorides to tungstates and molybdates, and also to the applications thereof.

This process may, specifically, be used for synthesizing, starting from the corresponding chlorides, alkaline-earth metal tungstates and molybdates that can be used for research and industry such as, for example, calcium, magnesium, barium and strontium tungstates and molybdates.

But it may also be used for extracting alkaline-earth metals from media in which they are found in the form of chlorides.

Thus, the process according to the invention may especially be used in the reprocessing of spent nuclear fuels, for recovering the alkaline-earth fission products present in a molten chloride medium.

It may also be used in the pollution control of chloride-rich effluents such as, for example, domestic or industrial wastewaters.

### PRIOR ART

Essentially two types of pyrochemical process for reprocessing spent nuclear fuels are known: processes in molten fluoride media and processes in molten chloride media.

The processes in molten chloride media that are currently studied result in two final waste streams:
a salt flux, composed of fission products in the form of chlorides, dissolved in a lithium chloride/potassium chloride (LiCl/KCl) eutectic, these fission products being alkali metals (caesium and rubidium), alkaline-earth metals (strontium and barium) and lanthanides (yttrium, cerium, lanthanum, praseodymium, gadolinium, neodymium, samarium, europium, terbium, dysprosium); and
a non-salt flux, composed of fission products and of activation products in metallic form (molybdenum, technetium, rhodium, palladium, ruthenium, niobium, zirconium and iron).

The salt flux represents a high-level waste which is completely soluble in water, hence the need to process it in a long-term chemically stable form. Its processing via a vitrification of the type of that used for processing final high-level waste resulting from hydrometallurgical processes for reprocessing spent nuclear fuels such as the PUREX process, cannot be envisaged due to its high chlorine content (≈60% by weight of the waste).

Specifically, since chlorine can only be incorporated within a silicate-based vitreous matrix up to 1 to 2 wt %, the vitrification of such a flux would make it necessary to dilute it at least 30 times, which would result in a completely unacceptable volume of high-level waste.

One solution to this problem would consist in pretreating this salt flux so as to eliminate the chlorine therefrom and to selectively recover the fission products that it contains.

As regards the alkaline-earth fission products, namely strontium and barium, it has been shown that they can be recovered, when they are in the form of molten chlorides, via the precipitation of double phosphates (V. A. Volkovich et al., Journal of Nuclear Materials, 323 (2003), 49-56 [1]).

However, the formation of alkaline-earth metal double phosphates depends on the nature of the solvent used.

Thus, the precipitation of double phosphates is effective in a sodium chloride/potassium chloride (NaCl/KCl) eutectic or in pure lithium chloride (LiCl) at 750° C. whereas it is not very quantitative in an LiCl/KCl mixture at 550° C.

Furthermore, the synthesis of barium tungstate and molybdate has been carried out in a molten nitrate (NaNO₃ or KNO₃) medium (P. Afanasiev, Materials Letters (2007), article in press [2]).

Finally, alkaline-earth metal tungstates have been produced in molten chloride media by high-temperature evaporation methods. These studies were carried out in the context of the synthesis of single crystals. Thus, A. R. Patel et al. (Journal of Crystal Growth 23 (1974), 95-100 [3]) used an NaCl/LiCl flux at 950° C. whereas A. Packter et al. (Journal of Crystal Growth 18 (1973), 86-93 [4]) and S. K. Arora et al. (Crystal Research and Technology 41 (2006), 1089-1095 [5]) worked in an LiCl flux at 900° C.

Insofar as the solvent used in the pyrochemical processes in a molten chloride medium is an LiCl/KCl eutectic, it would therefore be desirable to have a process which makes it possible to effectively, and as far as possible selectively, extract strontium and barium when these are in the form of chlorides in an LiCl/KCl eutectic.

It turns out that, in the context of their studies, the inventors have observed that, unexpectedly, the reaction between alkaline-earth metal chlorides and suitably chosen precursors of tungsten and of molybdenum, in a solvent constituted of an LiCl/KCl mixture or of pure potassium chloride, leads to a complete or almost complete conversion of these chlorides to tungstates and molybdates, which precipitate and thus constitute a solid phase which can then be easily separated from the rest of the reaction medium.

They have moreover observed that, even more unexpectedly, this conversion does not take place for the alkali metal chlorides present in the reaction medium and therefore appears to be specific to alkaline-earth metal chlorides.

It is on these observations that the present invention is based.

### SUMMARY OF THE INVENTION

A first subject of the invention is a process for converting an alkaline-earth metal chloride to at least one salt chosen from the tungstates and molybdates of this metal, which process comprises:

the reaction of the alkaline-earth metal chloride with at least one precursor of tungsten or of molybdenum chosen from tungsten oxides, molybdenum oxides, tungstates and molybdates, this reaction being carried out in a solvent composed of KCl or of an LiCl/KCl mixture, and at a temperature at least equal to the melting point of this solvent.

In the aforegoing and in what follows, the terms “tungstate” and “molybdate” are taken in their usual meaning, namely that they denote salts containing either the divalent anion WO₄²⁻ in the case of a tungstate, or the divalent anion MoO₄²⁻ in the case of a molybdate.

In accordance with the invention, the precursor of tungsten or of molybdenum is, preferably, chosen from tungsten(VI) oxide or tungsten trioxide (WO₃), molybdenum(VI) oxide or molybdenum trioxide (MoO₃), tungstates and molybdates of alkali metals, in particular of sodium, potassium and lithium.

It is of course possible to use several precursors of tungsten or of molybdenum and, in particular, mixtures of alkali metal tungstates such as, for example, Na₂WO₄/K₂WO₄ or Li₂WO₄/K₂WO₄ mixtures, or mixtures of alkali metal molybdates such as, for example, Na₂MoO₄/K₂MoO₄ or Li₂MoO₄/K₂MoO₄ mixtures.

The solvent is itself advantageously chosen as a function of the tungsten or molybdenum precursor.

Thus, when this precursor is a tungsten oxide, and in particular WO₃, it is advisable to use potassium chloride as solvent, in which case, as the melting point of KCl is 771° C., the reaction is preferably carried out at a temperature ranging from 800 to 900° C.

On the other hand, when this precursor is a molybdenum oxide, a tungstate or a molybdate, and in particular MoO₃, an alkali metal tungstate or molybdate, it is possible to use both an LiCl/KCl mixture and potassium chloride as solvent.

As such, in this case, it is preferred to use an LiCl/KCl mixture, and in particular a mixture having a composition close or identical to the eutectic composition, that is to say having a weight ratio of lithium chloride to potassium chloride of 40/60 to 50/50, and ideally of 45.5/55.5 (eutectic), so that its melting point is 350° C. or close to this value. The reaction is then preferably carried out at a temperature ranging from 400 to 600° C. and, better still, of the order of 500° C.

In any case, the alkaline-earth metal chloride and the precursor of tungsten or of molybdenum are, preferably, present in the solvent in stoichiometric proportions (AE/W or AE/Mo molar ratio=1), and the time during which they are left to react together is one or more hours, preferably of the order of 1 to 10 hours.

The conversion process which has just been described may advantageously be utilized for extracting one or more alkaline-earth metals from a medium in which they are found in the form of chlorides, and in particular from a medium in which this or these alkaline-earth metals are already dissolved in molten KCl or in a molten LiCl/KCl mixture, which is, for example, the case for the alkaline-earth fission products present in the salt waste produced during the reprocessing of a spent nuclear fuel in a molten chloride medium.

Therefore, another subject of the invention is a process for extracting at least one alkaline-earth metal from a medium containing this metal in the form of a chloride, which comprises:

a₁) the conversion of the alkaline-earth metal chloride to at least one salt chosen from the tungstates and molybdates of this metal via a conversion process as defined previously; then

b₁) the recovery of the salt resulting from this conversion.

In the case where the alkaline-earth metal chloride is already dissolved in molten KCl, then step a₁) of the extraction process preferably comprises:
the addition, to the medium, of a potassium tungstate or molybdate; and
keeping the medium at a temperature at least equal to the melting point of KCl for a sufficient time so that the conversion of the alkaline-earth metal chloride to tungstate or molybdate can take place.

Similarly, in the case where the alkaline-earth metal chloride is already dissolved in a molten LiCl/KCl mixture, then step a₁) of the extraction process preferably comprises:
the addition, to the medium, of a mixture of tungstates or molybdates of lithium and of potassium, these two metals then being, if possible, present in this mixture in a weight ratio identical to that which they have in the LiCl/KCl mixture; and
keeping the medium at a temperature at least equal to the melting point of LiCl/KCl mixture for a sufficient time so that the conversion of the alkaline-earth metal chloride to tungstate or molybdate can take place.

It is thus possible to extract the alkaline-earth metal from the medium in which it is found without necessarily modifying the qualitative, or even quantitative, composition of the solvent of this medium, which is very substantial in the context of the reprocessing of a spent nuclear fuel where it is highly desirable to be able to recycle the solvent considering the very large volumes of solvent used.

In the case where the alkaline-earth metal chloride is not already dissolved in molten KCl or in a molten LiCl/KCl mixture, then step a₁) of the extraction process comprises:
the mixing of the alkaline-earth metal chloride and of a solvent composed of KCl or of an LiCl/KCl mixture;
the addition, to the mixture thus obtained, of at least one precursor of tungsten or of molybdenum chosen from tungsten oxides, molybdenum oxides, tungstates and molybdates; and
the heating of the assembly at a temperature at least equal to the melting point of the solvent for a sufficient time so that the conversion of the alkaline-earth metal chloride to tungstate or molybdate can take place.

In any case, step b₁) may be carried out by any technique conventionally used for separating a solid phase (which is here constituted by the tungstate, the molybdate or the mixture of tungstates or molybdates of the alkaline-earth metal) from a liquid phase (which is here constituted by the remainder of the reaction medium).

Preferably, the medium is a salt flux from a process for reprocessing a spent nuclear fuel in a molten chloride medium and the alkaline-earth metal thus extracted is a fission product, namely strontium or barium.

The use of the extraction process according to the invention within the context of the reprocessing of a spent nuclear fuel in molten chloride media has proved to exhibit many advantages.

Specifically, this extraction process makes it possible to recover the alkaline-earth fission products present in a salt flux completely or almost completely (yield of 98 to 100%), selectively (since the alkali metal fission products are not themselves extracted) and, moreover, in the form of tungstates or molybdates which are very readily soluble in water and, thus, not very sensitive to leaching, and which are therefore capable of being used as matrices for the long-term containment of these fission products.

Another subject of the invention is therefore a process for reprocessing a spent nuclear fuel in a molten chloride medium, which comprises the extraction of at least one alkaline-earth fission product, in the form of a tungstate or a molybdate, from a salt flux via the extraction process as defined previously.

Advantageously, this reprocessing process further comprises the conversion of the tungstate or molybdate of the alkaline-earth fission product to a ceramic for the long-term containment of this fission product.

This conversion may be carried out according to the methods conventionally used in the manufacture of ceramics, that is to say typically by putting the tungstate or molybdate into the form of a powder, compacting this powder and sintering the thus compacted powder.

The conversion process according to the invention may also be utilized for synthesizing alkaline-earth metal tungstates and molybdates from the corresponding chlorides, such as, for example, the tungstates and molybdates of calcium, magnesium, barium or strontium.

Therefore, an additional subject of the invention is a process for synthesizing at least one salt chosen from the tungstates and molybdates of alkaline-earth metals, which process comprises:

a₂) the conversion of an alkaline-earth metal chloride to at least one salt chosen from the tungstates and molybdates of this metal by a conversion process as defined previously; then

b₂) the recovery of the salt resulting from this conversion.

The invention will be better understood in light of the remainder of the description which follows and which relates to examples of the implementation of the process according to the invention for converting molten chlorides of strontium and of barium to tungstates.

Of course, these examples are only given by way of illustration of the subject of the invention and do not under any circumstances constitute a limitation of this subject.

### BRIEF DESCRIPTION OF THE DRAWINGS

FIG. 1 represents the X-ray diffraction pattern recorded on a powder obtained at the end of the conversion, by the process according to the invention, of a strontium chloride to strontium tungstate in the absence of any other chloride.

FIG. 2 represents the X-ray diffraction pattern recorded on a powder obtained at the end of the conversion, by the process according to the invention, of a barium chloride to barium tungstate in the absence of any other chloride.

FIG. 3 represents the X-ray diffraction pattern recorded on a powder obtained at the end of the conversion, by the process according to the invention, of a strontium chloride to strontium tungstate in the presence of rubidium and caesium chlorides.

FIG. 4 represents the X-ray diffraction pattern recorded on a powder obtained at the end of the conversion, by the process according to the invention, of a barium chloride to barium tungstate in the presence of rubidium and caesium chlorides.

### DETAILED SUMMARY OF EXAMPLES OF IMPLEMENTATION OF THE PROCESS ACCORDING TO THE INVENTION

### Example 1

### Conversion of SrCl₂ to SrWO₄ in the Absence of any Other Chloride

In an alumina crucible, the following were mixed at ambient temperature (20-25° C.): 1 g of SrCl₂, having a purity greater than 99%, and 9 g of an LiCl/KCl eutectic, formed from 4.005 g of LiCl and from 4.995 g of KCl; then, still at ambient temperature, 2.0567 g of K₂WO₄ were added to the mixture thus obtained.

The crucible was introduced into a quartz tube that was sealed and that was heated at 500° C. at a rate of around 5° C. per minute. The tube was kept at 500° C. for 5 hours, then it was cooled at a rate of around 2° C. per minute until a temperature of 300° C. was reached. The contents of the crucible was then quenched in air.

A solid was thus recovered, which was submerged in ultrapure water at high temperature (25° C. or 100° C.) in order to make the SrCl₂ that had not reacted pass into solution, then the assembly was filtered over a Büchner funnel, using a filter with a cut-off threshold of 0.45 μm. The filtration residue was washed with water then dried at 120° C.

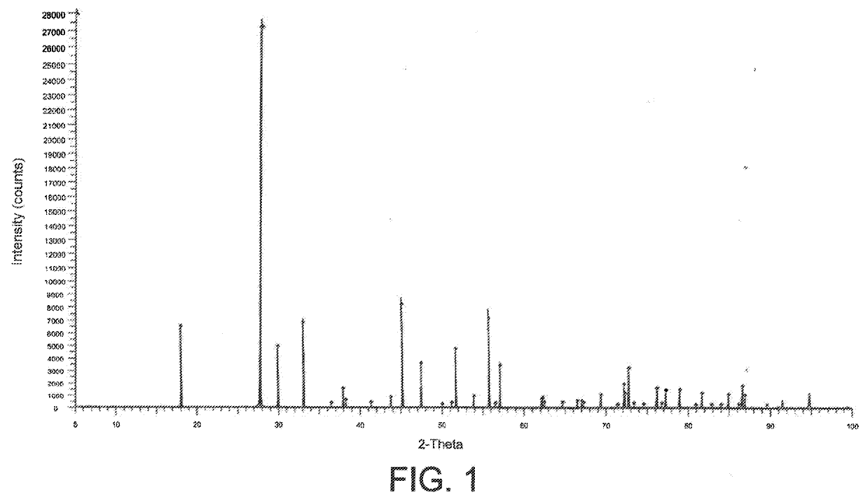

A powder was thus obtained, which was analysed by X-ray diffraction. The X-ray diffraction pattern of this powder is represented in FIG. 1. This diffraction pattern shows a good agreement between the peaks recorded and those from the card calculated for SrWO₄ (01-085-0587 (C)), proving that the SrCl₂ initially mixed with the eutectic was indeed converted to SrWO₄.

The yield of the reaction was determined by weighing the SrWO₄ and comparing the result of the weighing with the theoretical mass corresponding to 100% reaction. This yield is greater than 90%.

### Example 2

### Conversion of BaCl₂ to BaWO₄ in the Absence of any Other Chloride

The same procedure as that described in Example 1 above was followed, except that 1 g of BaCl₂ (instead of the gram of SrCl₂) was dissolved in the eutectic and that 1.5657 g of K₂WO₄ was used.

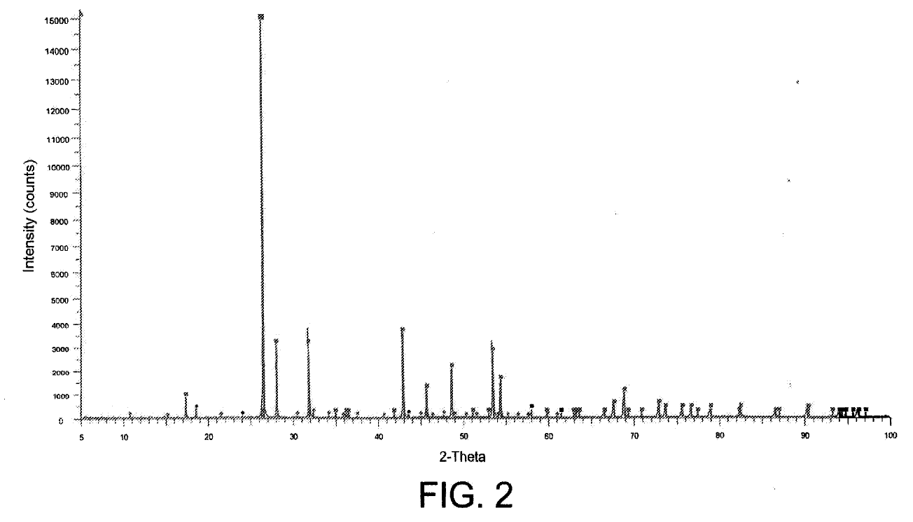

The X-ray diffraction pattern of the powder thus obtained is represented in FIG. 2. This diffraction pattern shows a good agreement between the peaks recorded and those of the card calculated for BaWO₄ (00-043-0646 (*)), proving that the BaCl₂ initially mixed with the eutectic solvent was indeed converted to BaWO₄.

The yield of the reaction, determined by weighing the BaWO₄ and comparing the result of the weighing with the theoretical mass corresponding to 100% reaction, is greater than 90%.

### Example 3

### Conversion of SrCl₂ to SrWO₄ in the Presence of RbCl and CsCl

The same procedure as that described in Example 1 above was followed except that 1 g of a mixture of SrCl₂, RbCl and CsCl (1/0.5/0.5 w/w) was dissolved in the eutectic instead of the gram of SrCl₂.

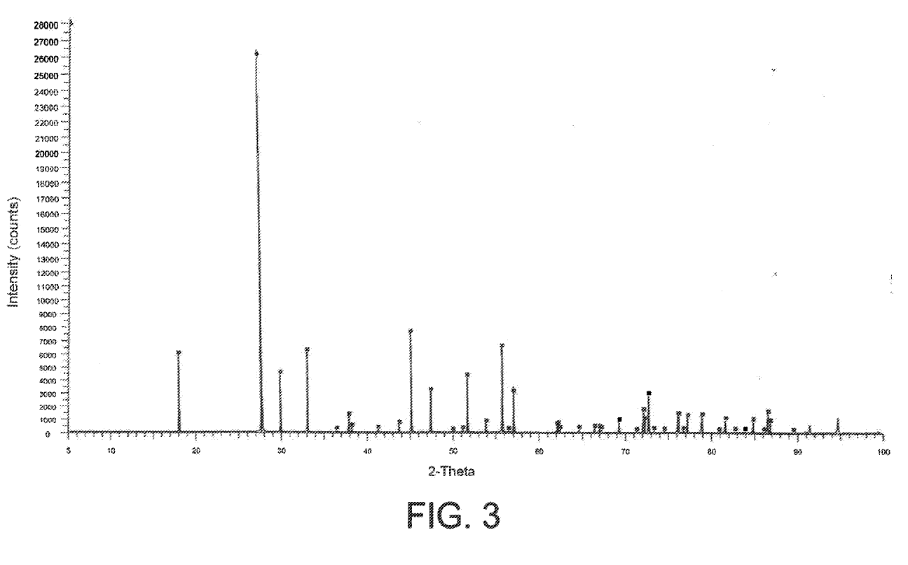

The X-ray diffraction pattern of the powder thus obtained is represented in FIG. 3.

This diffraction pattern is almost identical to that represented in FIG. 1, which proves, on the one hand, that only the SrCl₂ was converted to tungstate and, on the other hand, that the presence of the two alkali metal chlorides in the reaction medium had no influence on this conversion.

The yield of the reaction (determined as in Example 1) is greater than 90%.

### Example 4

### Conversion of BaCl₂ to BaWO₄ in the Presence of RbCl and CsCl

The same procedure as that described in Example 2 above was followed except that 1 g of a mixture of BaCl₂, RbCl and CsCl (1/0.5/0.5 w/w) was dissolved in the eutectic instead of the gram of BaCl₂.

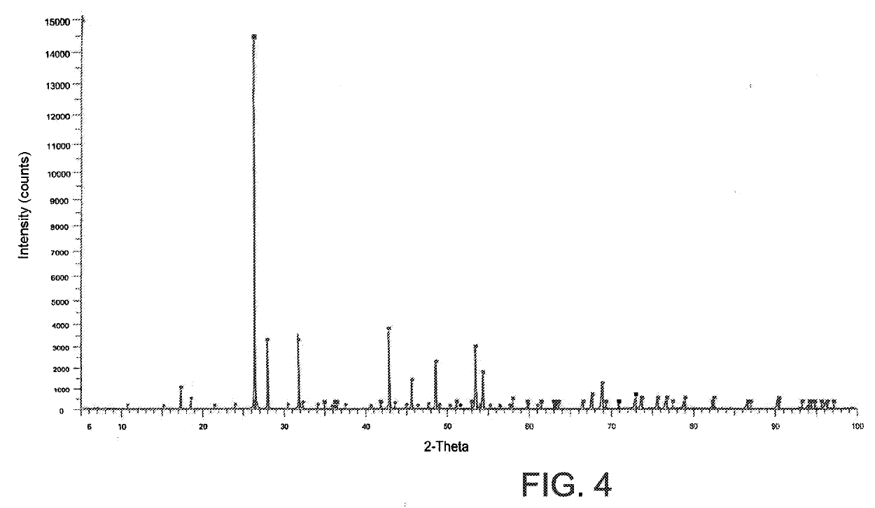

The X-ray diffraction pattern of the powder thus obtained is represented in FIG. 4.

This diffraction pattern is almost identical to that represented in FIG. 2, which proves, here too, that only the BaCl₂ was converted to tungstate and that the presence of the two alkali metal chlorides in the reaction medium had no influence on this conversion.

The yield of the reaction (determined as in Example 2) is greater than 90%.

### REFERENCES CITED

[1] V. A. Volkovich et al., Journal of Nuclear Materials, 323 (2003), 49-56
[2] P. Afanasiev, Materials Letters (2007), article in press
[3] A. R. Patel et al., Journal of Crystal Growth 23 (1974), 95-100
[4] A. Packter et al., Journal of Crystal Growth 18 (1973), 86-93
[5] S. K. Arora et al., Crystal Research and Technology 41 (2006), 1089-1095

1. A process for converting an alkaline-earth metal chloride to at least one salt chosen from tungstates and molybdates of this metal, the process comprising:
reacting the alkaline-earth metal chloride with at least one precursor of tungsten or of molybdenum chosen from tungsten oxides, molybdenum oxides, tungstates and molybdates, said reaction being carried out in a solvent constituted by potassium chloride (KCl) or by a lithium chloride/potassium chloride (LiCl/KCl) mixture and at a temperature at least equal to the melting point of this solvent.

2. The process according to claim 1, in which the precursor of tungsten or of molybdenum is chosen from tungsten(VI) oxide, molybdenum(VI) oxide, alkali metal tungstates and alkali metal molybdates.

3. The process according to claim 2, in which the alkali metals are sodium, potassium and lithium.

4. The process according to claim 2, in which the precursor of tungsten or of molybdenum is tungsten(VI) oxide, and the solvent is potassium chloride.

5. The process according to claim 4, in which the reaction is carried out at a temperature ranging from 800° C. to 900° C.

6. The process according to claim 2, in which the precursor of tungsten or of molybdenum is molybdenum(VI) oxide, an alkali metal tungstate or molybdate, and the solvent is an LiCl/KCl mixture which has a weight ratio of the lithium chloride to the potassium chloride of 40/60 to 50/50.

7. The process according to claim 6, in which the reaction is carried out at a temperature ranging from 400° C. to 600° C.

8. The process according to claim 1, in which the alkaline-earth metal chloride and the precursor of tungsten or of molybdenum are present in the solvent in stoichiometric proportions.

9. A process for extracting at least one alkaline-earth metal from a medium in which it is found in the form of a chloride, the process comprising:
a) converting the alkaline-earth metal chloride to at least one salt chosen from the tungstates and molybdates of this metal via a conversion process according to claim 1; and
b) recovering the salt resulting from this conversion.

10. The process according to claim 9, in which the medium comprises the alkaline-earth metal chloride in a molten LiCl/KCl solvent and step a) comprises:
adding to the medium a mixture of lithium and potassium tungstates or molybdates; and
keeping the medium at a temperature at least equal to the melting point of the solvent for a sufficient time so that the conversion of the alkaline-earth metal chloride to tungstate or molybdate can take place.

11. The process according to claim 10, in which the mixture of lithium and potassium tungstates or molybdates has a weight ratio of the lithium to the potassium that is identical to that of the solvent.

12. The process according to claim 9, in which the medium is a salt flux from a process for reprocessing a spent nuclear fuel in a molten chloride medium.

13. The process according to claim 9, in which the alkaline-earth metal is strontium or barium.

14. A process for reprocessing a spent nuclear fuel in a molten chloride medium, the process comprising:
extracting at least one alkaline-earth fission product, in the form of at least one tungstate or molybdate, from a salt flux via the extraction process according to claim 9.

15. The process according to claim 14, further comprising:
converting the tungstate or molybdate of the alkaline-earth fission product to a ceramic for the long-term containment of this fission product.

16. A process for synthesizing at least one salt chosen from tungstates and molybdates of alkaline-earth metals, the process comprising:
a) converting an alkaline-earth metal chloride to at least one salt chosen from the tungstates and molybdates of this metal by a process according to claim 1; and
b) recovering the salt resulting from this conversion.

17. The process according to claim 16, in which the alkaline-earth metal is calcium, magnesium, barium or strontium.
